(19) United States
(12) Patent Application Publication
(10) Pub. No.: US 2023/0336352 A1
(43) Pub. Date: Oct. 19, 2023

(54) SYSTEM AND METHOD FOR AN IMPROVED CLOUD BASED E-SIGNATURE PLATFORM

(71) Applicant: MILLENNIUM INFO TECH INC., PRINCETON, NJ (US)

(72) Inventor: Ramana Krosuri, Princeton, NJ (US)

(73) Assignee: MILLENNIUM INFO TECH INC., PRINCETON, NJ (US)

(21) Appl. No.: 18/211,611

(22) Filed: Jun. 20, 2023

Related U.S. Application Data
(63) Continuation-in-part of application No. 17/162,976, filed on Jan. 29, 2021.

(51) Int. Cl. H04L 9/32; H04L 9/08; H04L 67/02

(52) U.S. Cl. CPC H04L 9/3228; H04L 9/0822; H04L 67/02

(57) ABSTRACT

A method executed by an engine of a computing device is described. Login credentials are received by the engine from a user via a graphical user interface (GUI) of the computing device. The engine then queries a database to identify a user profile based on the login credentials and grants the user access to a cloud-based electronic signature platform. The user is prompted to upload a document. The engine receives an action from the user on a module of the cloud-based electronic signature platform and executes the action on the document. The module may be: an in-person signing module, a secure documentation module, an e-notarization module, a capture module, a secure documentation transmission module, a fingerprint recognition module, a retina recognition module, and/or a facial recognition module, among others.

### CROSS-REFERENCE TO RELATED APPLICATION

This Application is a United States Non-Provisional Patent Application and Continuation-In-Part (CIP) Patent Application that claims priority to U.S. Non-Provisional patent application Ser. No. 17/162,976 filed on Jan. 29, 2021, which is incorporated by reference herein in its entirety.

### FIELD OF THE EMBODIMENTS

The field of the invention and its embodiments relate to an improved cloud-based e-signature platform.

### BACKGROUND OF THE EMBODIMENTS

Signatures are needed for a variety of legally-binding agreements. Since obtaining a person's hand-written signature on a document can be a time-consuming task, electronic signatures have become widely accepted in various professional fields. Many electronic signature solutions e-mail an electronic document to an individual for execution. After the user executes the electronic document, the user can simply attach it to an e-mail response to the sending party. E-mailing such documents poses a security risk, since the e-mail response may be intercepted by an unintended and malicious recipient. Moreover, many conventional electronic signature services require many steps to be performed between a signature requestor and a signer, often making obtaining an electronic signature a burdensome and mistake-prone task.

Thus, what is needed is a cloud-based e-signature platform that allows for quick and easy execution of signatures. Moreover, what is needed is a cloud-based e-signature platform that allows one to send, receive, and manage documents in a single platform and provides reliability, consistency, scalability, and security.

Review of related technology:

U.S. Pat. No. 10,614,264 B2 describes a system, a computer-readable storage medium, and a computer-implemented method for signing a document involving generating copies of the document in response to receiving actions to perform on the document. In particular, the present invention describes a web service that can transmit a document for signing to a client device such that the document is viewable through graphical user interfaces while the underlying content of the document remains non-editable by the client devices through the web service. Responsive to receiving actions, the web service can generate one or more copies of the document that may include modifications that correspond to the received actions.

U.S. Pat. No. 10,628,596 B2 describes an e-signing workflow that enables an e-document to be signed by multiple parties including a document signer and a third-party, such as a guarantor. The e-signing workflow employs various online detours that enable addition of third parties to an e-document. The e-signing workflow enables a complete audit trail to be easily and automatically developed for a document sender and signers, and associated with a particular e-document. Privacy concerns are addressed by way of secure electronic communications that take place between the parties within the e-signing workflow. The e-signing workflow reduces reliance on e-mail for document execution insofar as most if not all relevant activities in the e-signing workflow take place within the workflow and result in storage of the e-document and all relevant information within the e-signing solution itself.

U.S. Pat. No. 10,511,732 B2, EP 2,580,705 B1, and U.S. Published Patent Application No. 2020/0092430 A1 describe techniques for signer-initiated electronic document signing via an electronic signature service using a mobile or other client device. Example embodiments provide an electronic signature service (“ESS”) configured to facilitate the creation, storage, and management of documents and corresponding electronic signatures.

U.S. Pat. No. 10,482,287 B2 describes systems and methods for managing electronic documents. In particular, the reference enable parties to an agreement outlined in an electronic document to add, track, and save electronic signatures associated with the electronic document. The reference also describes automatic identification of expiration information associated with the electronic document and generation of alerts for the electronic document based on the expiration information.

U.S. Pat. No. 10,361,871 B2 describes improved document processing workflows that provide a secure electronic signature framework by reducing attack vectors that could be used to gain unauthorized access to digital assets. In one embodiment of the invention, an electronically signed document is removed from an electronic signature server after signed copies of the document are distributed to all signatories. The electronic signature server optionally retains an encrypted copy of the signed document, but does not retain the decryption password. This limits the amount of data retained by the electronic signature server, making it a less attractive target for hackers. However, the electronic signature server still maintains audit data that can be used to identify a signed document and validate an electronic signature. For example, a hash of the document (or other document metadata) can be used to validate the authenticity of an electronically signed document based on a logical association between an electronic signature and the signed document.

U.S. Pat. No. 10,250,393 B2 describes techniques that allow for automatic signing of a digital document in response to some event and/or when the document satisfies some predefined condition. The document may be, for example, an agreement, a technical paper for publication, a press release or marketing materials, or any other digital document that might need to be assented to, approved by, and/or attributed to one or more persons or representatives. The techniques may further provide support for automatic signature tracking and notification in order to assist with auditability. In one example embodiment, the techniques are implemented in the context of an e-signature application or service, which may be installed locally on the user's computer or provided to the user via a network from a server. In one example embodiment, the e-signature service is configured to automatically impress a signer's signature into a given document, if the signer's pre-established auto-sign criteria is met.

U.S. Published Patent Application No. 2017/0039394 A1 describes systems and methods for requesting transmission of a document from a sender device to a signer device and for purposes of obtaining an e-signature from the signer device. In some example embodiments, the systems and methods establish and/or determine a physical proximity between a signer device and a sender device, such as via a handshake between the devices, and a document to be signed is provided to the signer device in response to the established physical proximity.

Various signature platforms exist. However, their means of operation are substantially different from the present disclosure, as the other inventions fail to solve all the problems taught by the present disclosure.

### SUMMARY OF THE EMBODIMENTS

The present invention and its embodiments relate to an improved cloud-based e-signature platform.

A first embodiment of the invention describes a method executed by an engine of a computing device. The method includes numerous process steps, such as: receiving login credentials from a user (e.g., a creator or a recipient of a document) via a graphical user interface (GUI) of a computing device and querying a database to identify a profile of the user based on the login credentials. The engine grants the user access to a cloud-based electronic signature platform and prompts the user to upload a document. The document may be a personal document, a professional document, or a business document, among other types of documents not explicitly listed herein. The engine receives the document from the user. Next, the engine receives an action from the user on a module of the cloud-based electronic signature platform, such as: an in-person signing module, a secure documentation module, an e-notarization module, a capture module, a secure documentation transmission module, and/or a recognition module, among others not explicitly listed herein. The recognition module may be a fingerprint recognition module, a retina recognition module, and/or a facial recognition module, among others not explicitly listed herein. The engine then executes the action on the document.

In examples where the module is the in-person signing module, the in-person signing module allows a third-party and the user to sign the document electronically and/or allows for an insertion of an in-person signature into the document. The in-person signing module is configured to grant access permission to the recipient of the document by the creator of the document such that the document is signable in presence of the recipient.

In examples where the module is the secure documentation module, the secure documentation module is configured to enable a one-time password (OTP) functionality for a recipient of the document. The engine of the computing device also records a telephone number associated with a cellular device of the recipient of the document, generates the OTP, and transmits the OTP to the telephone number associated with the cellular device of the recipient of the document such that the OTP is authenticated during access of the document for signing.

In examples where the module is the e-notarization module, the e-notarization module is configured to: receive an addition, from the creator of the document, of recipients of the document. Next, e-notarization module is configured to: receive, from the creator of the document, an identification of a subset of the recipients of the document as designated notaries, and prompt the creator of the document to input parameters associated with the notaries. The parameters include: a first name of each of the notaries, a last name of each of the notaries, and an email address of each of the notaries. Next, each of the notaries receive the document. When each of the notaries opens the document, the engine of the computing device prompts each of the notaries to input information. The information comprises a license state, expiry date of a maximum of 9 days from the date of signing, and other information that may be deemed necessary. Such input of information is for security and verification purposes (e.g., the notary who received and opened the document is the notary who was authorized to receive such document). The engine of the computing device then receives the input information from the notaries and an executed signature from each of the notaries. Next, the engine of the computing device automatically generates a notarized seal and transmits the notarized document from the notaries to the cloud-based electronic signature platform for viewing and/or downloading by one or more parties.

A second embodiment of the present invention describes a computer system. The computer system includes: one or more processors, one or more memories, one or more cameras, and one or more computer-readable hardware storage devices. The one or more computer-readable hardware storage devices contain program code executable by the one or more processors via the one or more memories to implement a method. The method includes: receiving login credentials from a user (e.g., a creator or a recipient of a document) via a graphical user interface (GUI) of the computer system and querying a database to identify a profile of the user based on the login credentials. The method then grants the user access to a cloud-based electronic signature platform and prompts the user to upload a document. The document may be a personal document, a professional document, or a business document, among other types of documents not explicitly listed herein. The method then includes receiving the document from the user and receiving an action from the user on a module of the cloud-based electronic signature platform. The module may be: an in-person signing module, a secure documentation module, an e-notarization module, a capture module, a secure documentation transmission module, and/or a recognition module, among others not explicitly listed herein. The recognition module may be a fingerprint recognition module, a retina recognition module, and/or a facial recognition module, among others not explicitly listed herein. Next, the method includes: executing the action on the document.

In examples where the module is the capture module, the capture module is configured to: capture, via the one or more cameras of the computer system, an image of the user during a signature process, store the image in the user profile in the database, and utilize the image during an audit. It should be appreciated that any quantity of images may be captured.

In examples where the module is the facial recognition module, the facial recognition module is configured to: view a face of the user via the one or more cameras, map facial features of the face of the user mathematically to generate a facial image, and store the facial image in a user profile in the database. The facial recognition module comprises one or more deep learning algorithms that are configured to compare a live image captured from the one or more cameras to the facial image to verify an identity of the user. The one or more deep learning algorithms are not limited to any particular algorithms. The verification of the identity of the user is included with an executed signature on the document.

In examples where the module is the recognition module, the recognition module is configured to: capture, via the one or more cameras, an image of a portion of the user, store the image of the portion of the user in the user profile, and compare a live image of the portion of the user to the image of the portion of the user in the user profile to verify an identity of the user. The verification of the identity of the user is included with the executed signature on the document. It should be appreciated that the recognition module is the fingerprint recognition module or the retina recognition module and the portion of the user is a fingerprint or a retina.

In examples where the module is the secure documentation transmission module, the secure documentation transmission module allows for the document to be encrypted during transmission from one party to another. Any encryption means known to a person having ordinary skill in the art may be used.

A third embodiment of the present invention describes a computing device. The computing device includes one or more processors and one or more memories coupled to the one or more processors. The one or more processors are configured to implement a method. The method includes numerous process steps, such as: receiving login credentials from a user (e.g., a creator or a recipient of a document) via a graphical user interface (GUI) of the computing device and querying a database to identify a profile of the user based on the login credentials. The method then includes: granting the user access to a cloud-based electronic signature platform and prompting the user to upload a document. The document is a professional document, a business document, or a personal document. The method then includes receiving the document from the user and receiving an action from the user on a module of the cloud-based electronic signature platform. The module may be: an in-person signing module, a secure documentation module, an e-notarization module, a capture module, a secure documentation transmission module, and/or a recognition module, among others not explicitly listed herein. The recognition module may be a fingerprint recognition module, a retina recognition module, and/or a facial recognition module, among others not explicitly listed herein. The method then includes executing the action on the document.

In general, the present invention succeeds in conferring the following benefits and objectives.

It is an object of the present invention to provide an electronic signature software for professional, business, and personal documents.

It is an object of the present invention to provide an improved cloud-based e-signature platform that allows for quick and easy signatures.

It is an object of the present invention to provide an improved cloud-based e-signature platform that easily allows one to send, receive, and manage documents in a single platform.

It is an object of the present invention to provide an improved cloud-based e-signature platform that provides reliability, consistency, scalability, and performance.

It is an object of the present invention to provide an improved cloud-based e-signature platform that allows for the merging of reusable document templates.

It is an object of the present invention to provide an improved cloud-based e-signature platform that allows for selective real-time signing through video.

It is an object of the present invention to provide an improved cloud-based e-signature platform that allows for masking pages selectivity to individual users (based on access rights/privileges of each user).

It is an object of the present invention to provide an improved cloud-based e-signature platform that could allow for an online e-notary through video.

It is an object of the present invention to provide an improved cloud-based e-signature platform that allows for a mail merged e-signature request to a larger group of recipients.

### BRIEF DESCRIPTION OF THE DRAWINGS

FIG. 1 depicts a schematic diagram of a computer system configured to execute a method for an improved cloud-based e-signature platform, according to at least some embodiments disclosed herein.

FIG. 2 depicts a block diagram of a computing device used in a computer system, the computer system being configured to execute a method for an improved cloud-based e-signature platform, according to at least some embodiments disclosed herein.

FIG. 3 and FIG. 4 depict schematic diagrams of system architecture of a method for an improved cloud-based e-signature platform, according to at least some embodiments disclosed herein.

FIG. 5 is a block diagram of a computing device included within the computer system of FIG. 1 that is configured to execute a method for an improved cloud-based e-signature platform, in accordance with embodiments of the present invention.

FIG. 6 depicts a schematic diagram of a server farm for an improved e-signature platform, according to at least some embodiments disclosed herein.

FIG. 7 depicts a schematic diagram of the reassign/delegation process for an improved e-signature platform, according to at least some embodiments disclosed herein.

FIG. 8 depicts a flowchart of the escalation process for an improved e-signature platform, according to at least some embodiments disclosed herein.

FIG. 9 depicts a flowchart of the procedure for creating a template for an improved e-signature platform, according to at least some embodiments disclosed herein.

FIG. 10 depicts a flowchart of the procedure for using a template for an improved e-signature platform, according to at least some embodiments disclosed herein.

FIG. 11 depicts a flowchart of the biometric authentication process for an improved e-signature platform, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As described herein, “electronic signature” is used synonymously with “signature,” and is defined as a digital mark (e.g., a set of characters or an image representative of a name) generated with some electronic means (e.g., with a computer or other electronic device) and that is attached to, or otherwise associated with an electronic or digital document, and intended to serve the same purpose as a hand-written signature.

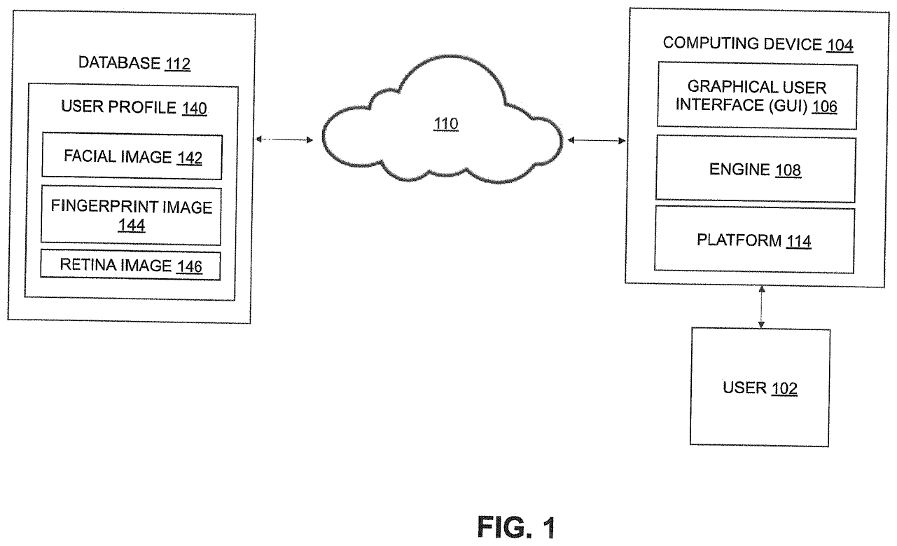

A computer system is depicted in at least FIG. 1. FIG. 1 includes a computing device 104. The computing device 104 may be a computer, a laptop computer, a smartphone, and/or a tablet, among other examples not explicitly listed herein. The computing device 104 may comprise an engine 108 that executes a method for an improved cloud-based e-signature platform. In other examples, the engine 108 may be an application, a software program, a service, or a software platform configured to be executable on the computing device 104.

A user 102 may interact directly with the engine 108 via a graphical user interface (GUI) 106 of the computing device 104. The user 102 may be a creator of a document 136 or a recipient of the document 136. The document 136 is a professional document, a business document, or a personal document, among others not explicitly listed herein. In examples, the document 136 may be: a document for designating beneficiary(ies) for a retirement account and death benefit, a document for a uniform consent to service of process, an affidavit of heirship, a notice of lien, a notice of lien release, a notice of authorization to add/remove a name from title, a U.S. Department of State issuance of a U.S. passport to a minor under the age of 16, a vehicle certificate of ownership/title application, advanced health directive forms, applications for admission to practice as an attorney, acknowledgments, jurats, handgun permits, an identity theft victim's complaint and affidavit, a power of attorney (POA), promissory note agreements, bank transfer service forms, supplemental marriage license applications, temporary guardianship agreement, a medical authorization for minors, and/or a motor vehicle bill of sale, among others not explicitly listed herein.

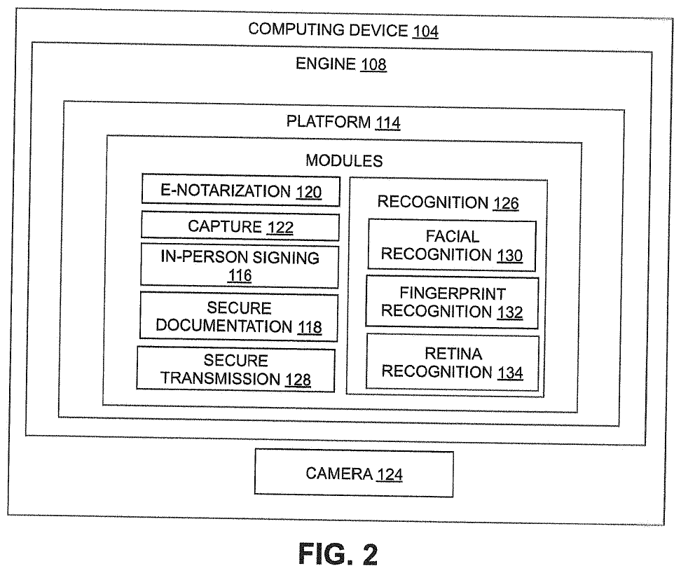

In examples, the engine 108 may receive, from the user 102 and via the GUI 106, login credentials. The login credentials may include a username, a password, etc. The engine 108 may then query, via a network 110, a database 112 to identify a user profile 140 of the user 102 based on the login credentials. The engine 108 then grants the user 102 access to a cloud-based electronic signature platform 114. Next, the engine 108 prompts the user 102 to upload the document 136. Once the engine 108 receives the uploaded document 136, the engine 108 receives an action from the user 102 on a module of the cloud-based electronic signature platform 114. As shown in FIG. 2, the module may be an in-person signing module 116, a secure documentation module 118, an e-notarization module 120, a capture module 122, a secure documentation transmission module 128, and/or a recognition module 126, among others not explicitly listed herein. It should be appreciated that the secure documentation transmission module 128 allows for the document 136 to be encrypted during transmission to a new location. Such encryption allows for security to be maintained during transit. The recognition module 126 may be a facial recognition module 130, a fingerprint recognition module 132, and/or a retina recognition module 134, among others not explicitly listed herein. The engine 108 may execute the action on the document 136.

Specifically, the in-person signing module 116 is configured to grant access permission to the recipient of the document by the creator of the document 136 such that the document 136 is signable in presence of the recipient.

The secure documentation module 118 is configured to enable a one-time password (OTP) functionality for the recipient of the document 136. It should be appreciated that the OTP is a password that is valid for only one login session or transaction, on a computer system or other digital device. Next, the engine 108 records a telephone number associated with a cellular device of the recipient of the document 136, generates the OTP, and transmits the OTP to the telephone number associated with the cellular device of the recipient of the document 136 such that the OTP is authenticated during access of the document 136 for signing.

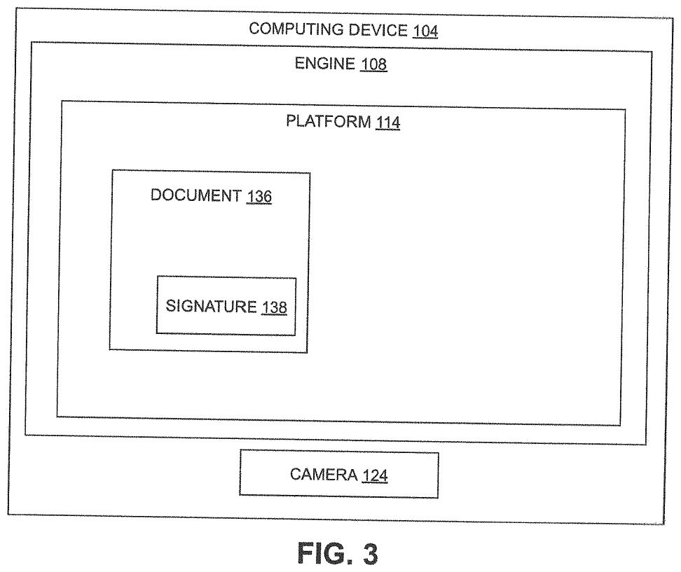

The e-notarization module 120 is configured to receive an addition of recipients of the document 136 from the creator of the document 136. Moreover, the e-notarization module 120 is configured to receive, from the creator of the document 136, an identification of a subset of the recipients of the document 136 as designated notaries for the document 136 and prompt the creator of the document 136 to input parameters associated with the notaries. The parameters include: a first name of each of the notaries, a last name of each of the notaries, and an email address of each of the notaries. The engine 108 may then receive the document 136 from the notaries. In response to the notaries opening the document 136, the engine 108 prompts each of the notaries to input information. The information includes a notary license state, expiry date and a name of the notary, among other pieces of information not explicitly listed herein. Such input of information verifies the identity of each of the notaries. Then, as shown in FIG. 3, the engine 108 receives the input information and an executed signature 138 on the document 136 from the notaries. In response, the engine 108 automatically generates a notarized seal and transmits the notarized document to the cloud-based electronic signature platform 114 for viewing and/or downloading by one or more parties.

In some examples, the computing device 104 comprises one or more cameras 124 of FIG. 2 and FIG. 3. The capture module 122 may be configured to capture, using the one or more cameras 124, one or more images of the user 102 during a signing process. The one or more images are not limited to any particular quantity of images. The capture module 122 may then store the one or more images in the user profile 140 in the database 112 and/or utilize the one or more images during an audit, if necessary.

In other examples, and as depicted in FIG. 2, the recognition module 126 may be a facial recognition module 130, a fingerprint recognition module 132, and/or a retina recognition module 134, among others not explicitly listed herein. The facial recognition module 132 may view a face of the user 102 via the one or more cameras 124 and map biometric facial features of the face of the user 102 mathematically to generate a facial image 142. The facial image 142 may be stored in the user profile 140 in the database 112. The facial recognition module 130 may also include one or more deep learning algorithms that are configured to compare a live image captured from the one or more cameras 124 to the facial image 142 to verify an identity of the user 102. The algorithms are not limited to any particular type of algorithm. The verification of the identity of the user 102 is included in the executed signature 138 on the document 136, as shown in FIG. 3.

In some examples, the fingerprint recognition module 132 may be used. The fingerprint recognition module 132 may capture, via the one or more fingerprint scanners or cameras 124, a fingerprint image 144 of the user 102 and store the fingerprint image 144 of the user 102 in the user profile 140 in the database 112. Then, the fingerprint recognition module 132 may compare a live image of the fingerprint of the user 102 to the fingerprint image 144 in the user profile 140 to verify the identity of the user 102. The verification of the identity of the user 102 is included in the executed signature 138 on the document 136, as shown in FIG. 3.

In additional examples, the retina recognition module 134 may be used. The retina recognition module 134 may capture, via the one or more retina scanners or cameras 124, a retina image 146 of the user 102 and store the retina image 146 in the user profile 140 in the database 112. Then, the retina recognition module 134 may compare a live image of the retina of the user 102 to the retina image 146 in the user profile 140 to verify the identity of the user 102. The verification of the identity of the user 102 is included in the executed signature 138 on the document 136, as shown in FIG. 3.

It should be appreciated that the cloud-based electronic signature platform 114 provides all features of a standard e-signature engine, along with the following features: merging reusable document templates, selective real-time signing through video, masking pages selectivity to individual users (based on access rights/privileges of each user), online e-notary through video, and/or mail merged e-signature request to a larger group of recipients, among others not explicitly listed herein.

System architecture for the instant invention is shown in FIG. 4. According to FIG. 4, the user 102 first navigates to a webpage via the Internet, which allows the user 102 access to the cloud-based electronic signature platform 114. Such step is shown as “1” in FIG. 4. A second step (e.g., step “2”) includes Route 53 forwarding the request to AWS Application Load Balancer (e.g., HTTP requests are redirected to HTTPS). “AWS” refers to “a subsidiary of Amazon that provides on-demand cloud computing platforms and APIs [application programming interface] to individuals, companies, and governments, on a metered, pay as you go basis.” Wikipedia. “Route 53” refers to “Amazon Route 53 (Route 53) [that] is a scalable and highly available Domain Name System (DNS) service.” Wikipedia. “HTTPS” refers to “Hypertext Transfer Protocol Secure (HTTPS) [that] is an extension of the Hypertext Transfer Protocol (HTTP). It uses encryption for secure communication over a computer network, and is widely used on the Internet.” Wikipedia.

A third step (e.g., step “3”) includes the request being forwarded to an EC2 instance in HTTPS. “EC2” refers to “Amazon Elastic Compute Cloud (EC2) [that] is a part of Amazon.com's cloud computing platform, Amazon Web Services (AWS), that allows users to rent virtual computers on which to run their own computer applications. EC2 encourages scalable deployment of applications by providing a web service through which a user can boot an Amazon Machine Image (AMI) to configure a virtual machine, which Amazon calls an ‘instance’, containing any software desired.” Wikipedia.

A fourth step (e.g., step “4”) includes the cloud-based electronic signature platform 114 connecting to the database 112 in AWS RDS using an application account. AWS RDS refers to “a distributed relational database service by Amazon Web Services (AWS). It is a web service running ‘in the cloud’ designed to simplify the setup, operation, and scaling of a relational database for use in applications.” Wikipedia.

Next, a fifth step (e.g., step “5”) of FIG. 4 includes the cloud-based electronic signature platform 114 saving and retrieving all documents in an AWS S3 private storage. “Amazon S3 . . . is a service offered by Amazon Web Services (AWS) that provides object storage through a web service interface. Amazon S3 uses the same scalable storage infrastructure that Amazon.com uses to run its e-commerce network” Wikipedia.

The sixth step (e.g., step “6”) then includes encryption of the S3 bucket by AWS using SSE-S3 keys. SSE refers to “searchable symmetric encryption [that] is a form of encryption that allows one to efficiently search over a collection of encrypted documents or files without the ability to decrypt them.” Wikipedia.

The seventh step (e.g., step “7”) includes the RDS Mysql database being encrypted at rest. “MySQL is an open-source relational database management system (RDBMS).” Wikipedia.

When the user 102 navigates to a subdomain of the cloud-based electronic signature platform 114, the user 102 is redirected to the user's SAML ID provider and gets redirected to the cloud-based electronic signature platform 114 after authentication in the eighth step (e.g., step “8”). SAML refers to “Security Assertion Markup Language [that] is an open standard for exchanging authentication and authorization data between parties, in particular, between an identity provider and a service provider.” Wikipedia.

The ninth step (e.g., step “9”) involves the facial, retina, and/or fingerprint recognition from the database 112. In a tenth step (e.g., step “10”), the cloud-based electronic signature platform 114 is configured to integrate with external vendors for certain features (e.g., to deliver emails, convert files, map countries, convert currency, etc.).

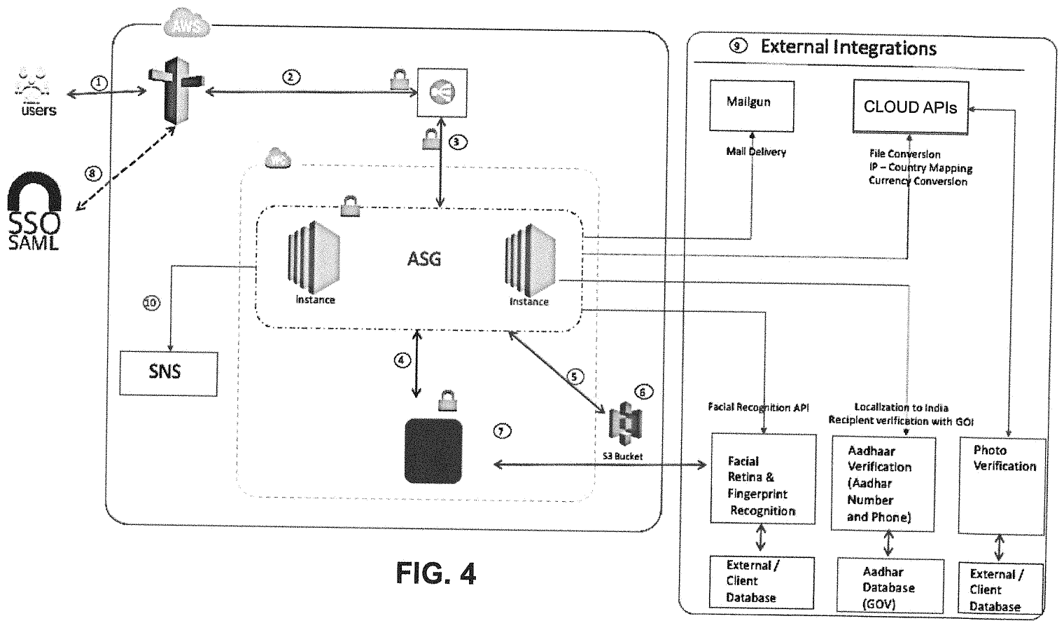

In some embodiments, the present invention may be a computer system, a method, and/or the computing device 104 (of FIG. 1) or the computing device 222 (of FIG. 5). For example, the computer system and/or the computing device 222 may be utilized to implement a method for an improved cloud-based e-signature platform.

A basic configuration 232 of a computing device 222 is illustrated in FIG. 5 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the engine 108, and program data 230. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method for an improved cloud-based e-signature platform. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

While the engine 108 was developed and hosted for customers across the world using the Amazon Web Services (AWS) Cloud Computing platform, the engine 108 is also available as an on-premises solution where the eSignature software can be deployed in the private infrastructure of organizations that requires the data (user and documents) to be within the organization's network for security and government compliance purposes. The engine 108 comes with both the options available on Cloud as well as On-Premises infrastructure as per the customer requirements.

In case of on-premises deployment, the user is routed to the engine 108 to carry out the eSignature process within the network of the Organization/Customer complying with the security governance structure in place by the Organization/Customer.

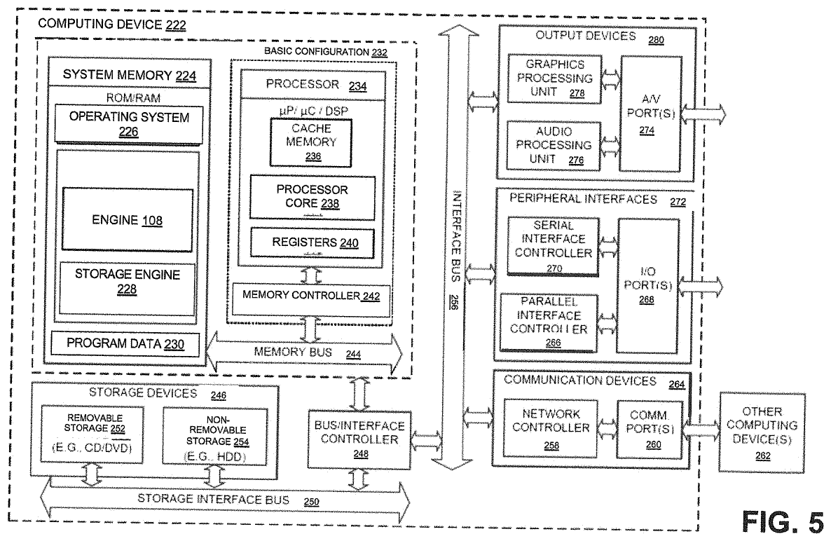

The same technology stack of the engine 108 and all of the features that are available to customers in the Software as a service (SaaS) version of the product are hosted on an AWS Cloud, are available on the on-premises version of the engine 108. The on-premises version of the engine 108 is shown in the server farm of FIG. 6.

The engine 108 uses Artificial Intelligence-based Biometrics Verification. The entire engine 108 shall be deployed within the Customer's information technology infrastructure as per the Customer's IT governance policies. This ensures no data leaves the organization and will be stored and controlled within the purview of the Customer. The users shall be able to access the engine 108 only when they are connected to the local network through secure LAN/WAN connections. Once they leave the network, the users cannot access the applications. This model provides maximum security and data privacy.

The engine 108 has a “reassign” feature that provides flexibility without losing control. The reassign feature in the engine 108 allows users to transfer responsibility for completing a document signature or approval process from one person to another. This can be useful in situations where the original signer is unavailable or unable to complete the task, or if the document needs to be reviewed or approved by someone else before it can be signed.

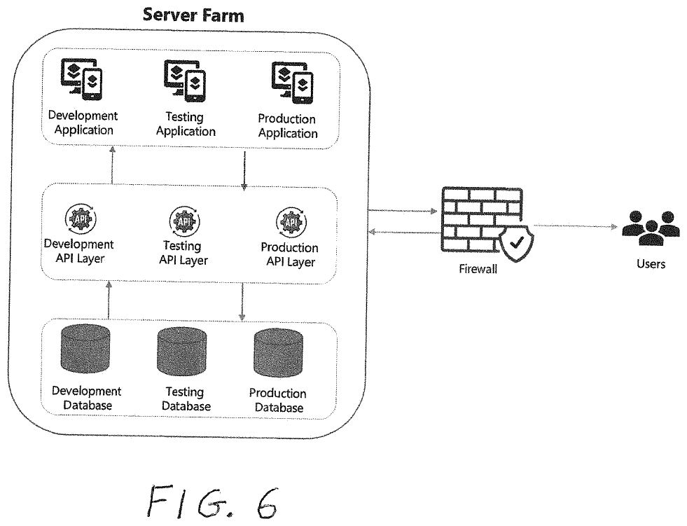

The reassign feature can add value to enterprise users by providing greater flexibility without compromising control and compliance over the document signature and approval process. For example, if a document is being signed by multiple parties and one of the signers is unavailable, the reassign feature allows the document to be quickly and easily reassigned to another person so that the signature process can continue without delay. Additionally, the reassign feature can be used to ensure that the right people are involved in the approval process, which can help to reduce errors and ensure compliance with internal policies and regulations. It also reduces the number of human interventions required, which streamlines the approval process and also makes it possible to track who did it and when. The audit trail captures every detail of the process so that there is complete visibility and transparency in the process. The reassign process is shown in FIG. 7.

The engine 108 provides for the execution of time sensitive documents. This process allows customers to manage time-sensitive documents effectively using the unique process defined by the engine 108. Adhering to timelines in the signing of time-sensitive documents is critical to maintaining the sanctity and validity of such contracts and documents. Also, executing such contracts could be business critical as well where the lost opportunity could be impacted significantly to business. In this scenario, setting up escalation rules within the document workflow is a critical step.

The “escalation” feature in the engine 108 allows a document or agreement to be passed on to a higher authority if it is not signed or acted upon within a certain period. This feature is often used in business settings to ensure that important agreements are not left in limbo and to ensure that tasks are completed promptly.

The escalation process typically involves setting up a series of rules or triggers that determine when a document should be escalated. For example, a rule might be set up to escalate a document if it has not been signed within 7 days of being sent. Once the trigger conditions are met, the document is automatically sent to the next person in the escalation chain, who is typically someone with more authority or responsibility.

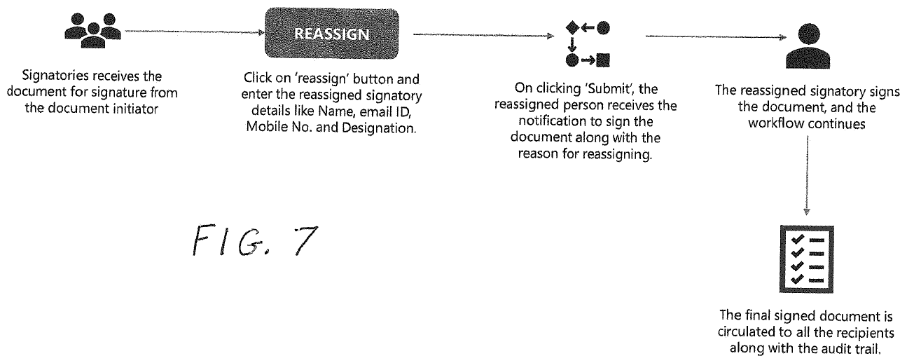

The escalation feature can be configured to send notifications, reminders, or even automated emails to the signer or to the next person in the escalation chain, to ensure that the document is signed or acted upon promptly. The escalation process is shown in FIG. 8.

The engine 108 has a templates feature. This feature provides reusable templates that are pre-designed documents that may be used as a starting point for creating a new document, and allow users to create and save a document with predefined fields that can be used multiple times. This can be helpful if a standard form or contract is used frequently, and it is beneficial to be able to quickly create and send it for signature.

To use reusable templates, the template is first created by creating a new document and adding any fields that may be beneficial to fill in, such as text fields, signature fields, or checkboxes. The engine 108 provides multiple field options that can be chosen from for a variety of data types. The template can then be saved for future use.

To use the template, it is selected from the template library and the predefined fields are added to the document. The fields can then receive the relevant information and the document sent for signature.

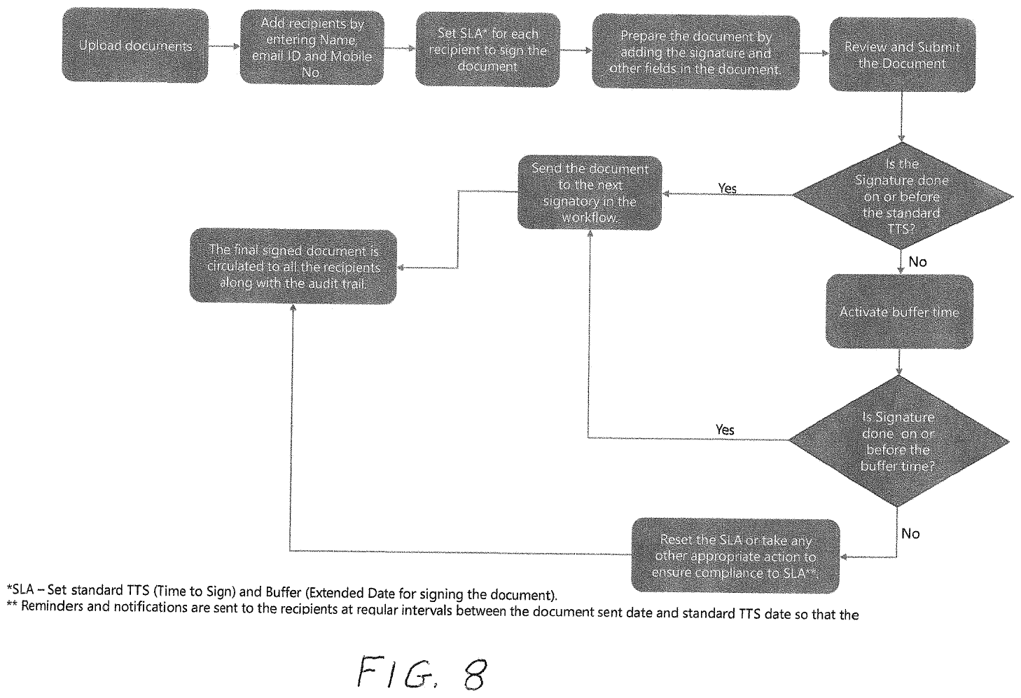

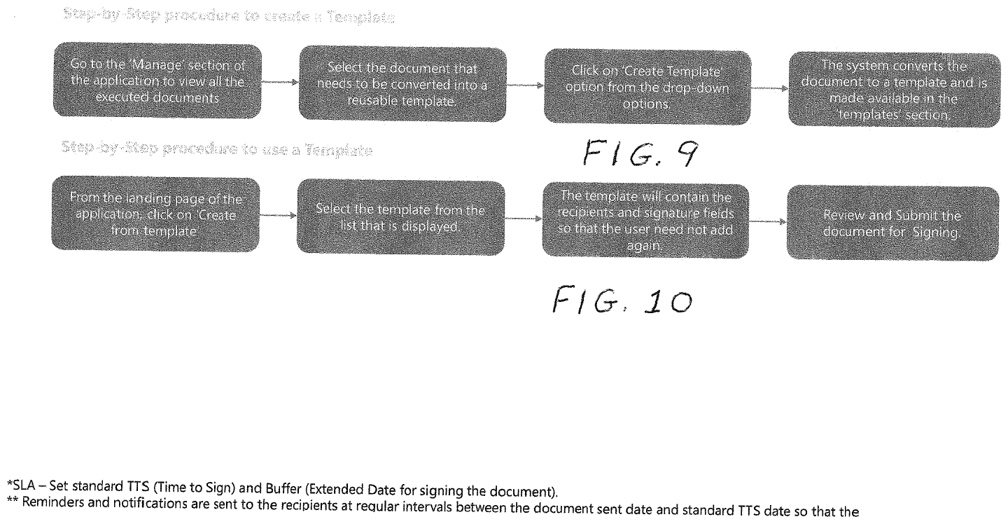

Reusable templates can save users considerable time and effort if the same type of document is frequently sent for signature. Reusable templates can also help ensure that a consistent and standardized document is used each time. The procedure for creating a template is shown in FIG. 9. The procedure for using a template is shown in FIG. 10.

The engine 108 leverages biometrics as an integral part of the process/workflow of the engine. Biometric-based identity verification techniques act as an effective deterrent for fraudulent activities in contract execution. Far fewer fraudulent actors try to attack a biometric check (both self photograph and video) compared to any other identity verification checks.

Biometrics refers to the use of unique physical characteristics, such as fingerprints, facial recognition, or iris scans, to identify or verify the identity of an individual.

The engine 108 uses biometrics to add a layer of security and authenticity to the process. Biometrics adds value to the eSignature process of the engine 108 by providing a more reliable method of identifying the signer. Traditional eSignature methods, such as using a typed name or a simple digital signature, can be forged or copied. By contrast, biometric data is much harder to falsify or replicate, making it a more secure method of identifying the signer.

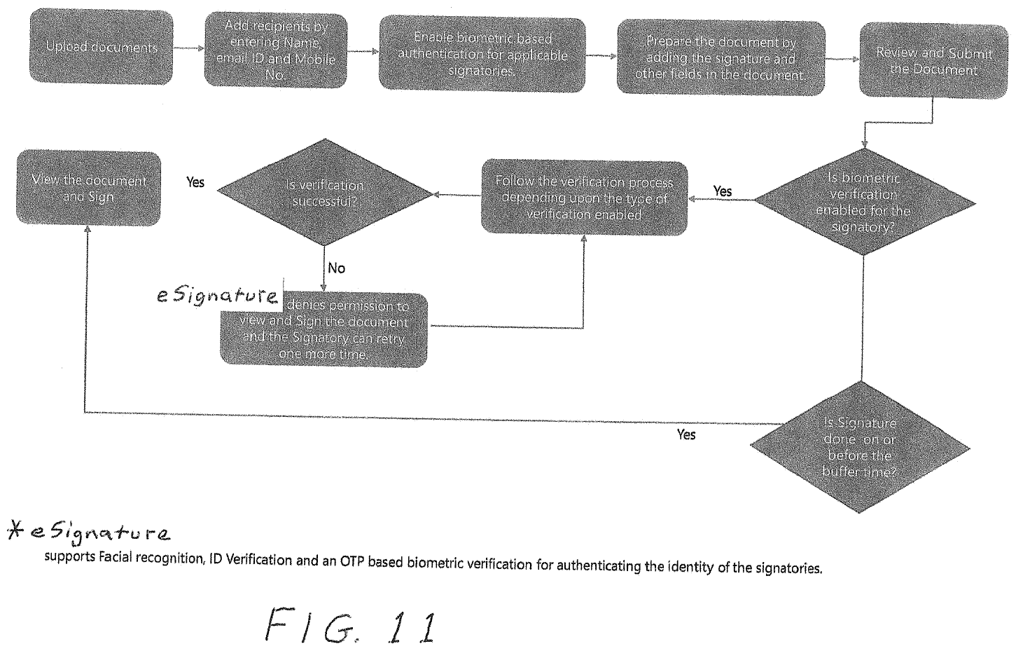

Biometric authentication ensures that only authorized individuals can access documents (especially those that are sensitive) or digitally sign documents on behalf of an appropriate organization. This greatly reduces the risk of unauthorized access or fraudulent activities. Additionally, it greatly reduces the likelihood of any potential human errors associated with traditional paper signing methods as physically present individuals are normally not needed at each step along the way for the document(s) to be validly signed. This allows more control over the individuals who have access to the document(s) without needing manual oversight every time a document(s) needs signing. The biometric authentication process is shown in FIG. 11.

The engine 108 uses artificial intelligence-based biometrics verification. For example, the engine 108 uses artificial intelligence based computer vision algorithms for carrying out the facial recognition process. In this process, the system takes three sample photographs of the signatory using the device camera and compares them with the reference image, either available in the system or extracted (using separate software programs) from any of the valid government-issued ID cards. The computer vision algorithm analyzes the pictures taken and compares them with the reference picture and gives the result in the form of a matching score. Only if the matching score is greater than the threshold score set, the signatory identity is successfully verified and can view and sign the document. Else, the signatory has to undergo the process again or contact the document owner for alternative steps.

The engine 108 captures the geo-location of the signer of the document. The engine 108 provides a feature where the location details of a signer can be captured and printed in the final Audit Trail. This enables document owners to have an eye on where the person is signing the document. This feature can be tagged for any person while submitting the document.

The engine 108 may operate in multiple languages. The engine 108 has customization where users can view the content of the page in different languages such as Hindi, French, Urdu, etc., This enables users from different regions across the globe to experience the engine 108 more comfortably with their local language.

The engine 108 is capable of third-party application integration. The engine 108 can be integrated with many types of third-party systems such as SAP, CRMs, etc. to provide a seamless user experience.

Documents may be authored within the engine 108 for an end-to-end document management experience. The engine 108 has an inbuilt document editor where users can create their documents instead of uploading documents from the local system. Once the document is authored, the same can be sent to the signatories for signatures.

A signed document can be verified using a checksum number to detect any fraudulent activities during the signing process. Doubt about the authenticity of a document that is processed is commonplace. The engine 108 can verify the authenticity of any document with a unique checksum number which will be sent along with the final signed document. The engine 108 uses a hash algorithm to generate checksum numbers. The main goal of doing this is to check whether tampering of the document has occurred during the signing process.

By following the below steps, the user can check for the authenticity of the signed document:

Step 1: https://verify.signulu.com
Step 2: Upload the final signed document.
Step 3: Enter the checksum number in the entry field

### Step 4: Click on Submit.

Step 5: The system will return the response stating whether the document is original or tampering of the document has occurred.
The above feature provides users/signers with the assurance that the document is executed in a safe and transparent process without any fraudulent activities.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a computing device, the method comprising:
navigating to a webpage to provide access to an on-premises, private electronic signature platform;
forwarding of a request to electronically sign a document to a Load Balancer in Hypertext Transfer Protocol (HTTP);
the request in HTTP being redirected to Hypertext Transfer Protocol Secure (HTTPS);
forwarding the request to an Elastic Compute Cloud (EC2 instance) in HTTPS;
connecting the electronic signature platform to the database in using an application account, the database containing data related to e-signature of the documents;
the electronic signature platform saving and retrieving documents in an object storage service that stores data within buckets (private storage), the data and documents relating to e-signature of the documents;
encrypting documents and data stored within the private storage such that accessing the documents and data requires a key for the object storage service, wherein the key is encrypted with a root key that is regularly rotated, the documents and data related to e-signature of the documents;
encrypting at rest an open source relational database (Mysql) that is set up, operated, and scaled; the relational database containing data related to the e-signature of documents;
navigating to a subdomain of the electronic signature platform;
being redirected to a Security Assertion Markup Language Identification (SAML ID) provider following by redirection to the electronic signature platform after authentication; and
authenticating whether a user of the electronic signature platform is authorized to access the electronic signature platform.

2. The method of claim 1, wherein the user is a creator of the electronically signed document or a recipient of the electronically signed document.

3. The method of claim 1,
wherein authenticating whether the user is authorized to access the electronic signature platform utilizes an in-person signing module,
the in-person signing module being configured to grant the access to a recipient of the document by a creator of the document such that the document to be electronically signed is signable in presence of the recipient.

4. The method of claim 1, further comprising:
failing to authenticate that the user is authorized to access the electronic signature platform; and
prompting the user to provide data required by the electronic signature platform to authenticate that access the electronic signature platform may be provided to the user.

5. The method of claim 1,
wherein the authenticating of whether the user is authorized to access the electronic signature platform utilizes a secure documentation module,
the secure documentation module being configured to enable a one-time password (OTP) functionality for a recipient of the electronically signed document.

6. The method of claim 5, further comprising:
recording a telephone number associated with a cellular device of a proposed recipient of the electronically signed document;
generating the OTP; and
transmitting the OTP to the telephone number associated with the cellular device of the proposed recipient of the electronically signed document, the secure documentation module determining whether the proposed recipient is authenticated to receive the electronically signed document.

7. The method of claim 1,
wherein the authenticating of whether the user is authorized to access the electronic signature platform utilizes an electronic notarization (e-notarization) module, and
wherein the e-notarization module is configured to:
receive an addition of recipients of the document from a creator of the document;
receive, from the creator of the document, an identification of a subset of the recipients of the document as notaries; and
prompt the creator of the document to input parameters associated with the notaries.

8. The method of claim 7, wherein the parameters are selected from the group consisting of:
a first name of each of the notaries, a last name of each of the notaries, and an email address of each of the notaries.

9. The method of claim 8, further comprising:
receiving, by the notaries, the document; and
in response to opening the document, prompting each of the notaries to input information, wherein the information comprises a license state, expiry date and a name.

10. The method of claim 9, further comprising:
receiving the input information from the notaries; and
receiving a signature from each of the notaries.

11. The method of claim 10, further comprising:
automatically generating a notarized seal; and
transmitting the notarized document from the notaries to the electronic signature platform for viewing and/or downloading.

12. A computer system comprising:
one or more processors;
one or more memories;
one or more scanners;
one or more cameras; and
one or more computer-readable hardware storage devices, the one or more computer-readable hardware storage devices containing program code executable by the one or more processors via the one or more memories to implement a method, the method comprising:
navigating to a webpage via the Internet to provide access to a cloud-based electronic signature platform;
forwarding of a request to electronically sign a document to an on-demand cloud computing platform including a Load Balancer (the Domain Name System (DNS) request) in Hypertext Transfer Protocol (HTTP);
the DNS request in HTTP being redirected to Hypertext Transfer Protocol Secure (HTTPS);
forwarding the DNS request to an Elastic Compute Cloud (EC2 instance) in HTTPS;
uploading the electronically signed document to the electronic signature platform;
connecting the cloud-based electronic signature platform to the database in a distributed relational database service using an application account, the database containing data related to e-signature of the documents;
the cloud-based electronic signature platform saving and retrieving documents in an object storage service that stores data within buckets that provide private object storage through a web service interface, the data and documents relating to e-signature of the documents;
encrypting documents and data stored within the private object storage such that accessing the documents and data requires a key for the private object storage, wherein the key is encrypted with a root key that is regularly rotated (searchable symmetric encryption keys), the documents and data related to e-signature of the documents;
encrypting at rest an open source relational database management system (RDS Mysql) that is set up, operated, scaled, and deployed in the cloud (RDS Mysql); the relational database containing data related to the e-signature of documents, the encrypting providing for selective masking of pages to individual users based on access rights/privileges of each user;
navigating to a subdomain of the cloud-based electronic signature platform;
being redirected to a Security Assertion Markup Language Identification (SAML ID) provider following by redirection to a cloud-based electronic signature platform after authentication; and
authenticating whether a user of the cloud-based electronic signature platform is authorized to access the cloud-based electronic signature platform.

13. The computer system of claim 12,
wherein authenticating whether a user of the cloud-based electronic signature platform is authorized to access the cloud-based electronic signature platform utilizes a capture module, and
wherein the capture module is configured to:
capture, via the one or more scanners or cameras, an image of the user during a signature process;
store the image in a user profile in the database; and
utilize the image during an audit.

14. The computer system of claim 12,
wherein authenticating whether a user of the cloud-based electronic signature platform is authorized to access the cloud-based electronic signature platform utilizes a facial recognition module, and
wherein the facial recognition module is configured to:
view a face of the user via the one or more scanners or cameras;
map facial features of the face of the user mathematically to generate a facial image; and
store the facial image in a user profile in the database.

15. The computer system of claim 14,
wherein the facial recognition module comprises one or more deep learning algorithms,
wherein the one or more deep learning algorithms are configured to compare a live image captured from the one or more scanner or cameras to the facial image to verify an identity of the user, and
wherein the verification of the identity of the user is included in a signature on the document.

16. The computer system of claim 12,
wherein authenticating whether a user of the cloud-based electronic signature platform is authorized to access the cloud-based electronic signature platform utilizes a recognition module,
wherein the recognition module is configured to:
capture, via the one or more scanner or cameras, an image of a portion of the user;
store the image of the portion of the user in a user profile; and
compare a live image of the portion of the user to the image of the portion of the user in the user profile to verify an identity of the user, and
wherein the verification of the identity of the user is included in a signature on the document.

17. The computer system of claim 16,
wherein the recognition module is selected from the group consisting of: a fingerprint recognition module and a retina recognition module, and
wherein the portion of the user is selected from the group consisting of: a fingerprint and a retina.

18. The computer system of claim 12, comprising a secure documentation transmission module that allows for the one or more documents to be encrypted during transmission.

19. A computing device comprising:
one or more processors; and
one or more memories coupled to the one or more processors, the one or more processors being configured to implement a method, the method comprising:
navigating to a webpage to provide access to an on-premises, private electronic signature platform;
forwarding of a request to electronically sign a document to a Load Balancer in Hypertext Transfer Protocol (HTTP);
the request in HTTP being redirected to Hypertext Transfer Protocol Secure (HTTPS);
forwarding the request to an Elastic Compute Cloud (EC2 instance) in HTTPS;
connecting the electronic signature platform to the database using an application account, the database containing data related to e-signature of the documents;
the electronic signature platform saving and retrieving documents in an object storage service that stores data within buckets, the data and documents relating to e-signature of the documents;
encrypting documents and data stored within the private storage such that accessing the documents and data requires a key for the object storage service, wherein the key is encrypted with a root key that is regularly rotated, the documents and data related to e-signature of the documents;
encrypting at rest an open source relational database (Mysql) that is set up, operated, scaled, and deployed; the relational database containing data related to the e-signature of documents;
navigating to a subdomain of the electronic signature platform;
being redirected to a Security Assertion Markup Language Identification (SAML ID) provider following by redirection to the electronic signature platform after authentication; and
authenticating whether a user of the electronic signature platform is authorized to access the electronic signature platform.

20. The computing device of claim 19, wherein the one or more documents are a professional document, a business document, or a personal document.
